(19) United States
(12) Patent Application Publication
(10) Pub. No.: US 2012/0178048 A1
(43) Pub. Date: Jul. 12, 2012

(54) DENTAL IMPLANT WITH MULTIPLE THREAD PATTERNS

(76) Inventor: Richard D. Cottrell, Lake Forest, IL (US)

(21) Appl. No.: 13/004,189

(22) Filed: Jan. 11, 2011

(51) Int. Cl. A61C 8/00

(52) U.S. Cl. 433/174

(57) ABSTRACT

A modified dental implant fixture designed with a multiple of three or more thread or groove patterns which provide adequate wall thickness for a deep female conical connection such that the threads or grooves transition from smaller to larger moving in the apical direction along the long axis of the dental implant.

### CROSS-REFERENCE TO RELATED APPLICATION

None.

### ABSTRACT

A modified dental implant fixture designed with a multiple of three or more thread or groove patterns such that the threads or grooves transition from smaller to larger moving in the apical direction along the long axis of the dental implant body. Such a modified implant maintains adequate wall thickness for a deep conical connection.

### BACKGROUND OF THE INVENTION

The present disclosure relates generally to dental implants, and more specifically to a dental implant having a deep female conical connection which can result in limited wall thickness. By combining an innovative thread or combination of thread and groove patterns that transition from smaller coronal to larger and deeper apical threads, which are helpful in providing greater primary stability, a dental implant that maintains adequate wall thickness, when a deep conical connection is utilized, is achieved.

Dental implants are used in place of missing natural teeth to provide a base of support for single or multiple teeth prosthetics. These implants generally include two components, the implant itself and the prosthetic mounting component referred to as an abutment upon which the final prosthesis is installed. The implant has apical and coronal ends, whereby the coronal end accepts the base of the prosthetic abutment using connection mechanisms of different designs. One such mechanism is a deep female conical receptor with an internal alignment or anti-rotational component such as a hex, double hex, spline or other single/multi-sided arrangement used for prosthetic alignment and anti-rotation stability. Deep female conical connections have been shown to prevent micro movement between the implant body and the abutment when loaded but can have the disadvantage of limited wall thickness especially if the implant is of a tapered design.

In practice, the implant body is surgically inserted in the patients jaw and becomes integrated with the bone. More specifically, the implant body is screwed or pressed into holes drilled in the respective bone. The surface of the implant body is characterized by macroscopic and microscopic features that aid in the process of osseointegration. Once the implant is fully integrated with the jaw bone, the abutment is ready to be mounted. For two-stage implant designs, the abutment passes through the soft tissue that covers the coronal end of the implant after healing and acts as the mounting feature for the prosthetic device to be used to restore oral function. Implants of the single-stage design extend at least partially through the soft tissue at the time of surgical insertion. The coronal end of the implant body acts as part of a built-in abutment design with the margin of the coronal collar usually being employed as the margin of attachment for the prosthesis used to restore oral function.

Both single and two stage implants are characterized by a central bore hole at their coronal ends that is generally threaded to accept a central screw to hold the abutment securely to the implant body. The exception would be some implants where the abutment is friction fit into the central bore hole and no screw is required. In any event, the implant, abutment, and screw are typically fabricated from titanium or a titanium alloy. Some implants are zirconia based, alumina based or sapphire based ceramics, and, in regions of high esthetic demands, the abutments are zirconia based. In some instances, ceramics and metals are combined to make a single component, though this is usually limited to the abutment component of the implant system. There is also promising research on the use of titanium zirconia alloys as well.

One of the original implant designs was the so-called Branemark type implant characterized by an external hex. The hex was originally used to insert the implant and later utilized as an external anti-rotational and alignment element. This design usually displays a bone loss pattern described as a cupping of the bone at the coronal end of the implant once loaded with occlusal forces. This cupping pattern usually stabilizes after about one year of function with vertical bone loss of approximately 2 mm. By that time, loss of bone critical to the predictable support of overlying soft tissue is lost. As implant designs evolved internal connections utilizing an internal hex became much more common. For example, Astra Tech Inc. (“Astra”) was one of the first companies to introduce a deep conical design and use a double hex as their internal orientation element.

In addition to having a more stable implant connection (deep female conical connection), Astra has also addressed the coronal bone loss by introducing micro threads at the coronal aspect of the implant body. This further modification is designed to distribute and transfer forces to the surrounding bone. However, clinicians are increasingly demanding dental implants with macro designs that achieve higher insertion torque values that generally translate to high initial implant stability. Prior Astra implants with a coronal flair had a single lead micro thread of 0.185 mm combined with a single lead apical thread of about 0.6 mm. To increase primary stability the micro threads were increased to 0.22 mm and made triple lead so as to be timed, together with having the same pitch, as the apical threads. This dramatically increased the required insertion torque and primary stability. Accordingly, in order to have more aggressive/deeper apical threads with wider spacing in combination with coronal micro threads of a similar dimension and still allow for adequate wall thickness for the deep female conical connection, an additional transitional thread pattern(s) of intermediate thread size(s) between the coronal micro threads and the larger apical threads is disclosed herein. However, the same thread pattern with inherent advantages can be utilized with any implant and is not limited to one with a deep conical connection.

Another advantage to a larger apical thread, in addition to increasing primary stability, is to increase surface area particularly on larger diameter implants when wall thickness is less of an issue. While apical threads in the size range of 0.6 to 0.66 may be ideal for implants in the 3.0 to 4.5 mm diameter, larger diameter implants have adequate distance between the central bore hole and the outer wall to allow for deeper apical threads. The resulting increase in surface area is particularly beneficial for large diameter, shorter implants which, depending on the clinical circumstances, would allow surgeons to avoid the maxillary sinus in the upper posterior region of the mouth.

More recent Astra implants have moved away from using an untimed micro thread of approximately 0.185 mm paired to a single lead apical thread of 0.6 mm, and now use a triple lead micro threads of about 0.22 mm timed to a single apical thread of approximately 0.66 mm. Meanwhile, U.S. Pat. No. 7,677,891 to Niznick (incorporated herein by reference) proposes quadruple lead (i.e.4X) coronal threads spaced 0.3 mm apart and timed to double lead (i.e. 2X) apical threads spaced 0.6 mm apart with the 4X coronal threads being spaced considerably greater than 0.22 mm. Referring to FIG. 1, the implant 10, includes a tapered body 12 with two externally-threaded regions 14 and 16. Proximal, externally-threaded region 14 includes V-shaped X4 lead threads all of which have the same pitch. Distal portion 16 includes V-shaped X2 lead threads. This type of implant design has a couple of disadvantages. First, in soft bone, the apical threads are limited to approximately 0.6 mm because coronal micro threads cannot be any larger than 0.3 mm and maintain crestal bone. Perhaps more critical, is the fact that a 2X apical thread increases the insertion speed. Specifically, if a sloped topped (e.g. U.S. Pat. No. 6,655,961) or asymmetric (e.g. copending application U.S. Ser. No. 12/494,510) coronal configuration is utilized, controlling the speed of the implant advancement into the host bone is essential. Accordingly, and as disclosed herein, the most apical thread should be a single thread (i.e. X1).

There is considerable prejudice among dentists and manufactures as to the benefits of tapered or straight walled implant designs. Some, like Astra, even combine a tapered coronal aspect with a parallel walled apical portion of the implant. Most now agree that some type of tapered apical cutting end, even on the parallel walled design, is desirable. This is demonstrated on Astra's recently introduced TX (tapered apex) design. Referring to FIG. 2 in particular, the implant 20, includes a straight walled body 22 with two externally-threaded regions 24 (proximal) and 26 (distal). The tapered apex 28 has been added to make initial installation, into holes drilled in the respective bone, easier.

However, both straight, tapered or a combination of tapered and straight bodied dental implants have their place in the field of implant dentistry depending on bone type and clinical application. For example, in the upper arch the bone is softer and the apical ends of adjacent teeth are closer together than in the lower arch. Therefore, a tapered design (that with a smaller apical end) fits between the roots of adjacent teeth more suitably while the tapered design compresses the softer maxillary bone upon insertion thus increasing implant primary stability at the time of placement. In the lower arch the bone is denser and root proximity is less of an issue so implants with parallel walls are considered more suitable by many clinicians.

A tapered implant with a truly more concave profile has not been utilized in the dental implant field. While Astra does transition from a straight apical end to a 6 degree flared coronal design, the transition is abrupt. What is proposed herein is a 2 and then a 5 degree concave flare (or any like progressive) transition be utilized. Besides allowing adequate wall thickness, another advantage, when combined with the proposed herein combination of thread sizes, is to increase implant primary stability as measured by resonance frequency analysis while possibly lowering the amount of torque required to seat the implant.

Accordingly, it is a general object of this dosclosure to provide a series of thread or a combination of groove and thread patterns that transition in spacing, size, pitch and depth such that adequate wall thickness for a deep internal female conical connection is maintained while allowing for an apical macro tread design that will result in greater primary stability for the dental implant while still keeping the rate of insertion within the limits that allow for either a sloped or asymmetric coronal configuration.

It is a another object of this disclosure to enable implants with a tapered implant body to maintain adequate wall thickness when utilizing a deep female internal conical connection and still allow for a macro tread design that will result in greater primary stability while still keeping the rate of insertion within the limits that allow for either a sloped or asymmetric coronal configuration to be aligned with the surrounding bony topography.

It is a further object of this disclosure to enable implants with a concave tapered implant body profile to maintain adequate wall thickness when utilizing a deep female internal conical connection and still allow for a macro thread design that will result in greater primary stability while still keeping the rate of insertion within the limits that allow of either a sloped or asymmetric coronal configuration to be aligned with the surrounding bony topography.

It is a more specific object of this disclosure to enable a large diameter, shorter length implants with deeper apical threads with increased surface area while maintaining adequate wall thickness for a deep conical connection and coronal micro threads.

These and other objects, features and advantages of this disclosure will be clearly understood through a consideration of the following detailed description.

### SUMMARY OF THE INVENTION

According to an embodiment of the present invention, there is provided a dental implant for implanting within a human jawbone having an implant body with an outer surface, a longitudinal axis, a coronal end and an apical end. The coronal end includes a deep female conical receptor that creates a wall thickness between the outer surface of the implant body and the receptor. At least three differently sized threaded regions are positioned on the outer surface of the implant body with each region transitioning from smaller to larger in the apical direction along the axis.

There is also provided a dental implant for implanting within the human jawbone having a longitudinal implant body with an outer surface, an apical end and a coronal end. A series of three or more thread patterns that start near the coronal end are in series with each one becoming progressively larger, deeper and/or wider in size when moving in the apical direction along the implant body.

### BRIEF DESCRIPTION OF THE DRAWINGS

FIG. 1 is a side elevational view of a prior art implant.

FIG. 2 is a side elevated view of a prior art implant having a tapered apex.

FIG. 3 is a cross-sectionals side elevated view of a prior art implant without thread timing or a tapered apex.

FIG. 4 is a cross-sectional side elevational view a prior art implant with thread timing and a tapered apex.

FIG. 5 is a cross-sectional side elevational view of an implant according to the principles of an embodiment of the present invention.

FIG. 6 is a cross-sectional side elevational view of an alternate embodiment of an implant.

FIG. 7 is a cross-sectional side elevational view of an alternate embodiment of an implant.

FIG. 8 is a cross-sectional side elevational view of an alternate embodiment of an implant.

FIG. 9 is a cross-sectional side elevational view of an alternate embodiment of an implant.

FIG. 10 is a cross-sectional side elevational view of an implant.

FIG. 11 is a side elevated view of an implant according to the principles of an embodiment of the present invention.

FIG. 12 is a side elevated view of an alternate embodiment of an implant.

FIG. 13a is a side elevated view of an alternate embodiment of an implant.

FIG. 13b is a cross-sectional side elevational view of the implant of FIG. 13a.

FIG. 13c is a top plan view of the implant of FIG. 13a.

FIG. 13d is a perspective view of the implant of FIG. 13a.

FIG. 13e is a detailed view of the variable thread form detail of FIG. 13a.

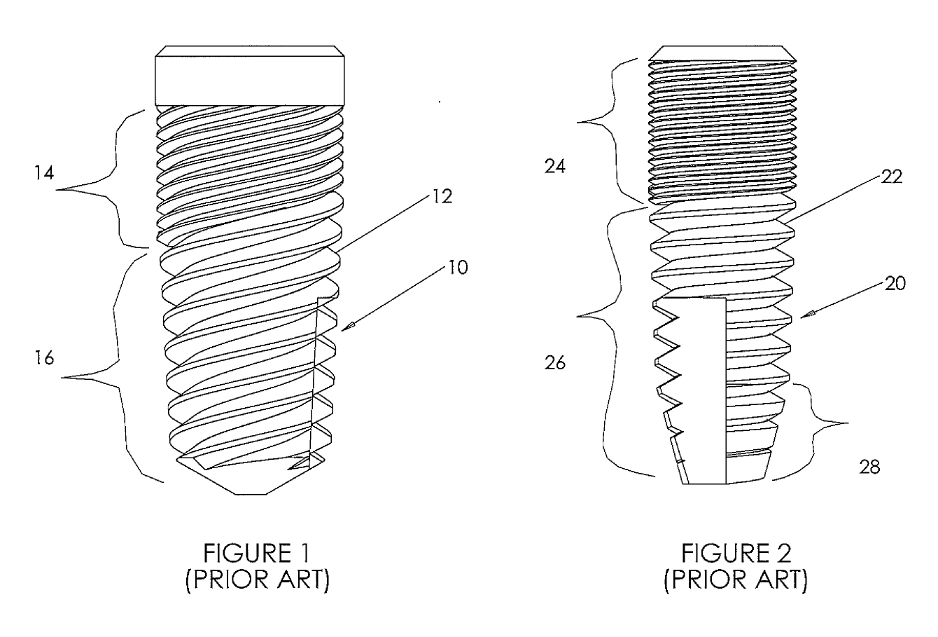

### DESCRIPTION OF THE PREFERRED EMBODIMENTS

An embodiment of the subject invention will now be described with the aid of numerous drawings and included measurement designations. Unless otherwise indicated, such measurements are used for explanatory purposes only and they are not deemed to be limiting of the disclosed embodiments herein. The purpose of describing these measurements is to illustrate that the concept of using three or more thread or groove patterns while maintaining adequate wall thickness for a deep conical connection can be utilized for a wide variety of implant sizes and designs.

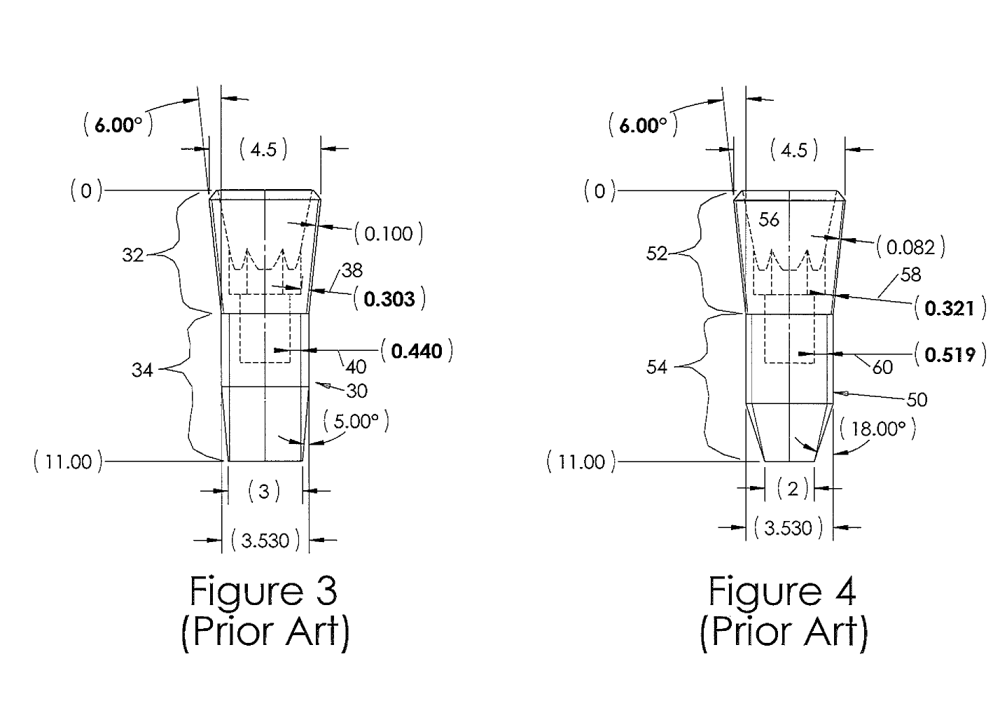

In any event, turning now to the Figures, and in particular FIG. 3, a prior art dental implant 30 is illustrated. This implant 30 is 11 mm long and has a step-wise diameter taper from 4.5 mm at its coronal end to 3 mm at its apical end. Two 60° thread patterns, at 1X to 1X are used on this implant 30. The coronal threads 32 are 0.185 mm apart with grooves 0.1 mm deep, while the apical threads 34 are 0.6 mm apart with grooves 0.325 mm deep. The deep female conical connection 36 is the space within the implant 30 denoted by the dotted lines. This design provides for an upper wall thickness 38 of 0.303 mm and a lower wall thickness 40 of 0.440 mm.

The prior art implant 50 of FIG. 4 is the next generation Astra design of FIG. 3 and is again 11 mm long, but instead of having a step-wise diameter taper from 4.5 mm to 3 mm (FIG. 3), it utilizes a tapered apex (similar to FIG. 2) going down to 2 mm. While such a tapered apex makes installation of the implant easier, the thread pattern needed to be adjusted in an attempt to increase wall thickness for the deep conical connection. Specifically, two 80° thread patterns, at 1X to 3X, are used on this implant 50. With 80°, the resulting reduced thread depth will increase the wall thickness. The coronal threads 52 are 0.22 mm apart with grooves 0.082 mm deep, while the apical threads 54 are 0.66 mm apart with grooves 0.246 mm deep. The deep conical connection 56 has an upper wall thickness 58 of 0.321 mm and a lower wall thickness of 0.519 mm. The change to 0.22 mm 3X coronal thread timing dramatically increases implant primary stability while the change to 80 degree threads increases all thickness for both the coronal threads 52 and the apical threads 54.

It has become apparent that an implant having a deep female conical connection is preferred to prevent micro movement between the implant and the abutment. In order to have both deeper apical threads that increase primary stability and coronal micro threads or grooves that better distribute force to the surrounding bone, an embodiment of the present invention adds at least one intermediate or middle thread to the pattern. This additional thread provides the necessary wall thickness to prevent implant breakage during function.

There have been studies claiming that certain thread timing patterns are more ideal than others. Specifically, that a 2X to 4X combination allows for the micro threads to follow partially in the path of the major apical thread with only a new middle thread being cut. However, Astra's 1X to 3X thread does much the same thing where the transition to 3X from 1X merely adds one smaller thread above and one below the major thread which itself transitions to a micro thread following the prior path of the major thread. While the 2X to 4X pattern avoids cross cutting the major apical threads, the 1X to 3X Astra pattern does essentially the same thing. Accordingly, in one of the solutions disclosed herein, a 1X to 2X to 3X thread pattern, there would be cross cutting for the 2X apical threads but not for the most coronal 3X micro thread. However, as long as the same thread pitch is maintained in a tapered implant design or one with a slightly concave coronal profile cross cutting is inconsequential as the bone is being compressed and expanded outward.

Cross cutting may be avoided for either a straight walled or tapered body implant using a 1X to 2X to 4X combination. However, bone gap jumping of up to 0.5 mm is clinically proven upon the immediate implant placement and therefore the only possible benefit might be for the ease of implant insertion as bone healing will fill in any cross threaded area in the bone. Taken to the extreme, and taking a 1X to 3X to 5X combination as an example, only the 5X portion would start to cross cut the 3X threads and only for the most coronal 20-25% or less. Furthermore, with a 1X to 2X to 4X, or a 1X to 3X to 6X no cross cutting would take place. For those knowledgeable in multiple lead thread timing this is well understood.

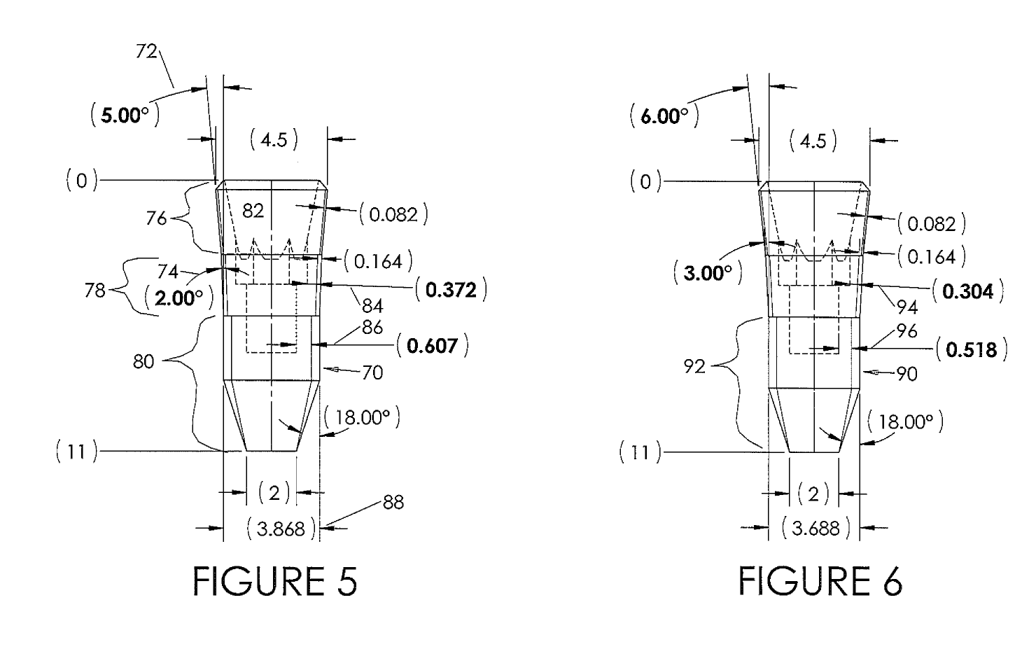

The utilization of a middle thread to the pattern will now be described. An example thereof is first shown in FIG. 5. In particular, this implant 70 is 11 mm long and has a step-wise diameter taper from 4.5 mm at its crown to 2 mm at its apex and is shown with 5° of coronal taper 72 and 2° of mid wall taper 74. Three thread patterns, 80° at 1X to 80° at 2X to 80° at 4X, are used on this implant 70. The coronal threads 76 are 0.22 mm apart with grooves 0.082 mm deep, the middle threads 78 are 0.44 mm apart with grooves 0.164 mm deep and the apical threads 80 are 0.88 mm apart with grooves 0.476 mm deep. The deep conical connection 82 has a mid wall thickness 84 of 0.372 mm and a lower wall thickness 86 of 0.607 mm, both of which exceed the parameters for prior art FIGS. 3 and 4.

While the straight walled apical diameter 88 has increased to 3.868 mm due to the increased thread depth in that region, the implant will go into the same diameter bone site as the prior art implant of FIG. 4. Further, since the apical wall thickness has been increased to 0.607 mm, the parallel walled region could become slightly tapered with a minimal apical wall thickness equal to or greater than 0.519 mm shown in FIG. 4. It should be noted that the implant of FIG. 4 does not allow the parallel walled section to become tapered because the apical threads were changed from 60° to 80° from the prior art of FIG. 3 in order to increase wall thickness for additional strength.

It will be appreciated that merely adding an intermediate or middle or transitional thread to any implant will not create the acceptable wall thickness. For example, implant 90 of FIG. 6 differs from FIG. 5 by using 6° of coronal and 3° of mid wall taper and again all three thread patterns are at 80° and the apical thread 92 depth is 0.328 mm. This allows a mid wall thickness 94 of only 0.304 mm and a lower wall thickness 96 of 0.518 mm. The lower wall thickness is acceptable but the middle wall thickness is less than prior art FIG. 4 and the parallel wall section could not become slightly tapered as for the implant shown in FIG. 5 as it is already 0.001 mm below minimum dimension per FIG. 4. Accordingly, the implant described in FIG. 5 is preferable to the implant of FIG. 6.

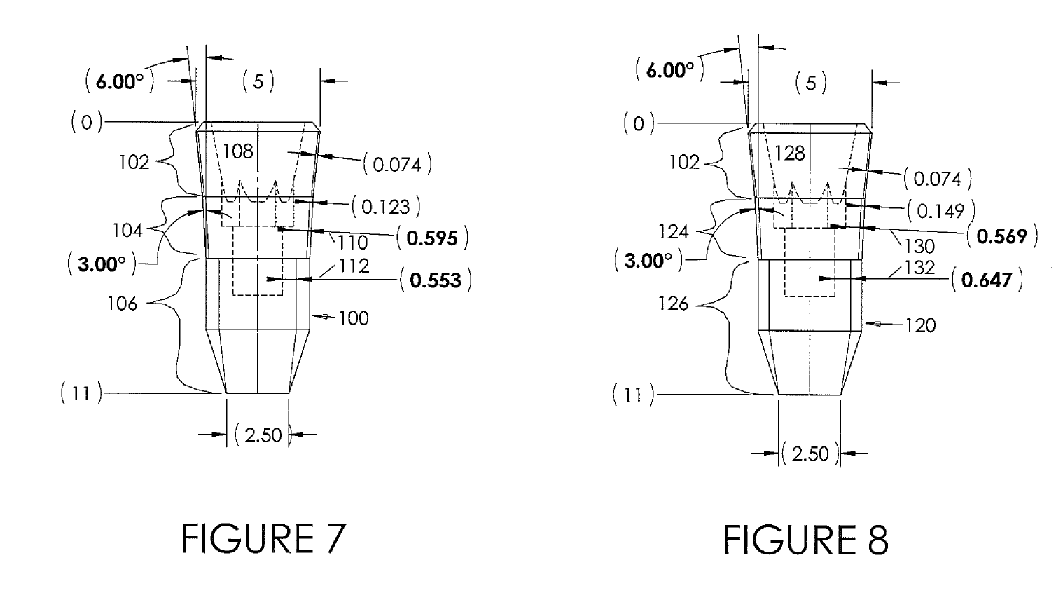

Three or more thread patterns can also be used on larger implants. For example, 11 mm long with step-wise diameter taper from 5 mm to 2.5 mm implants are shown in FIGS. 7 and 8. Referring first to FIG. 7, the implant 100 has a thread pattern of 60° at 1X to 80° at 3X to 80° at 5X. The coronal threads 102 are 0.2 mm apart with grooves 0.074 mm deep, the middle threads 104 are 0.33 mm apart with grooves 0.123 mm deep and the apical threads 106 are 1 mm apart with grooves 0.541 mm deep. The deep conical connection 108 has a mid wall thickness 110 of 0.595 mm and a lower wall thickness 112 of 0.553 mm.

The implant 120 of FIG. 8 has all three thread patterns at 80° with a 1X to 3X to 6X pitch. The coronal threads 122 are 0.2 mm apart with grooves 0.074 mm deep, the middle threads 124 are 0.4 mm apart with grooves 0.149 mm deep and the apical threads 126 are 1.2 mm apart with grooves 0.447 mm deep. The deep conical connection 128 has a mid wall thickness 130 of 0.569 mm and a lower all thickness 132 of 0.647 mm.

Referring now to FIG. 9, this implant 140 is 11 mm long and has a step-wise diameter taper from 4.5 mm at its crown to 2 mm at its apex. Three thread patterns, 80° at 1X to 80° at 2X to 80° at 3X, are used on this implant 140. The coronal threads 142 are 0.22 mm apart with grooves 0.082 mm deep, the middle threads 144 are 0.44 mm apart with grooves 0.164 mm deep and the apical threads 146 are 0.66 mm apart with grooves 0.246 mm deep. The deep conical connection 148 has a mid wall thickness 150 of 0.372 mm and a lower wall thickness 152 of 0.689 mm.

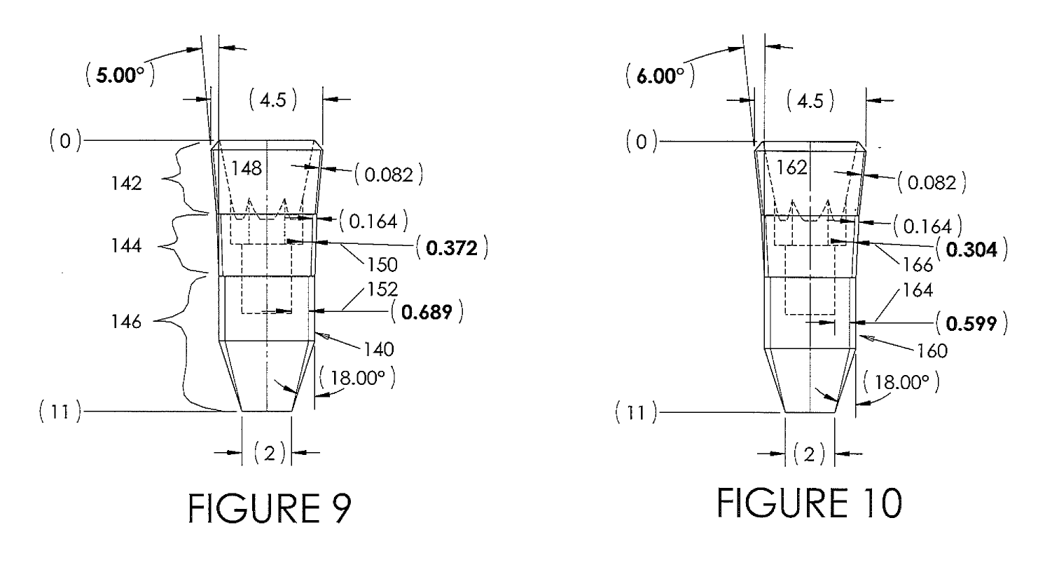

The slightly more tapered implant 160 of FIG. 10 has the same thread pattern and measurements of FIG. 9. However, as discussed with regard to FIG. 6, and due to the implant 160 dimensions, acceptable wall thickness is not created. While the deep conical connection 162 has a lower wall thickness 164 of 0.599 mm, the mid wall thickness 166 is merely 0.304 mm. Accordingly, the implant described in FIG. 9 is preferable to the implant of FIG. 10.

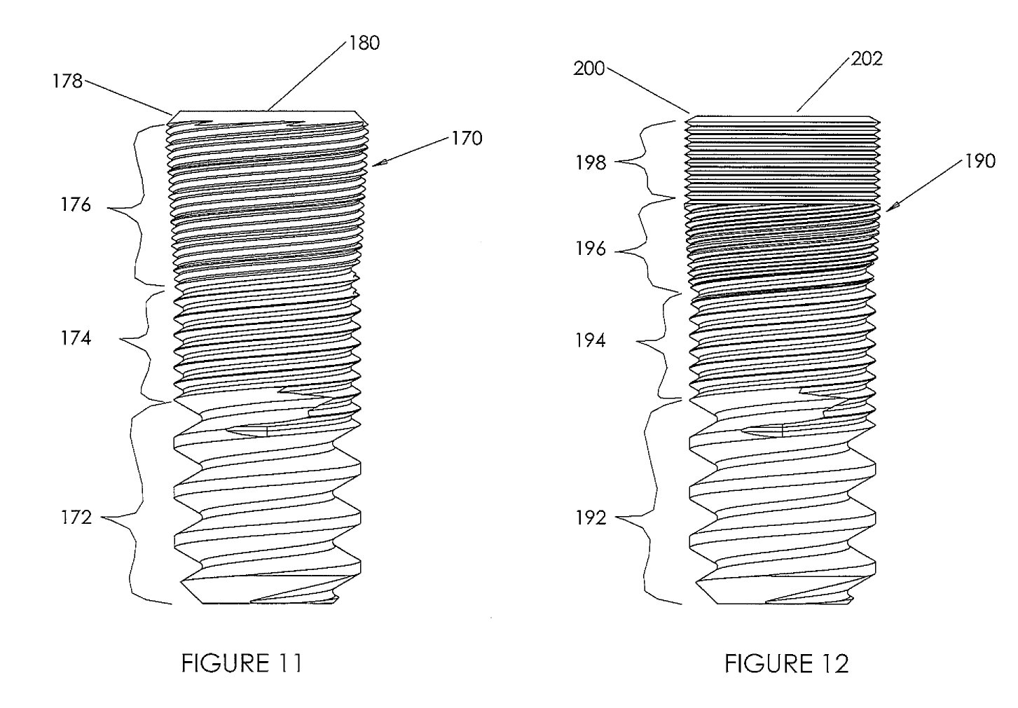

FIG. 11 shows a dental implant 170 with multiple thread patterns in profile. In this case, the deep apical threads 172 are followed by middle threads 174 and then coronal threads 176 up to the unthreaded portion 178 and top surface 180.

FIG. 12 shows a dental implant 190 with an addition set of threads. In particular, the deep apical threads 192 are followed by middle threads 194 and coronal threads 196 leading to parallel groove threads 198 before reaching the unthreaded portion 200 and the top surface 202. It will be appreciated that two or more parallel groove patterns may be employed.

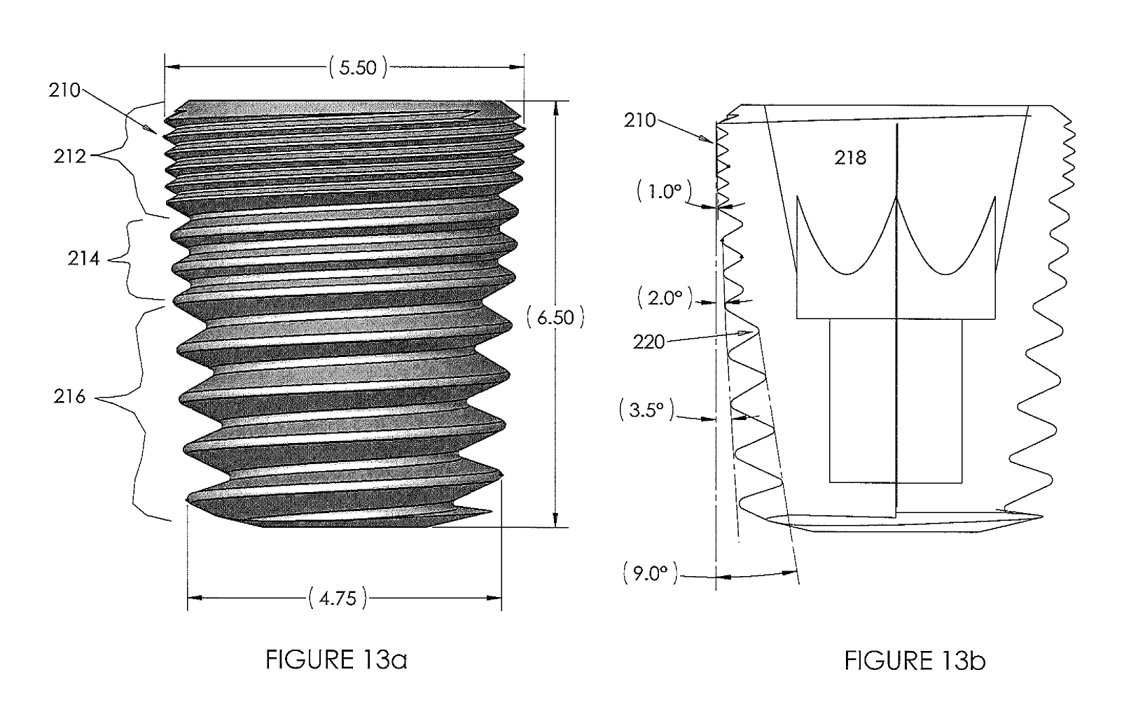

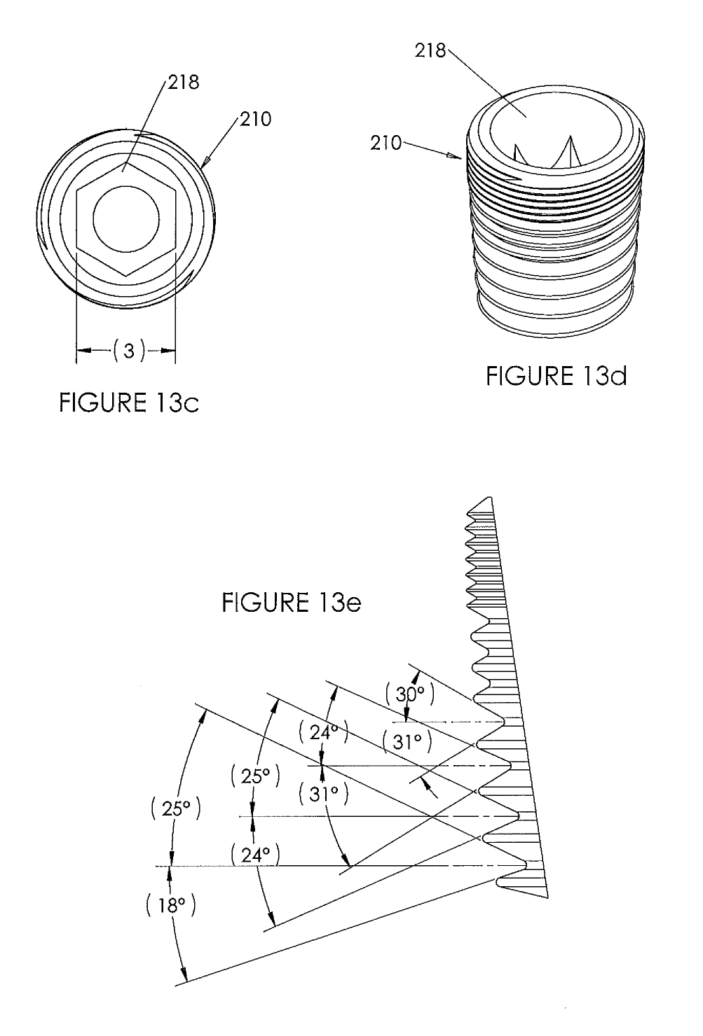

One of the more advantageous uses for the present invention is to allow for wider diameter dental implants; the same can be said of shorter and wider diameter implants. For example, FIG. 13a shows an implant 210 that is 6.50 mm long and has a diameter taper from 5.50 mm at its crown to 4.75 mm at its apex. Three thread patterns, a 1X to 2X to 3X all at 60°, are used on this implant 210. The coronal threads 212 are 0.25 mm apart with grooves 0:14 mm deep and the middle threads 214 are 0.375 mm apart with grooves 0.20 mm deep. As for the apical threads 216, they are shown with the apical minor diameters progressively being lowered, which results in the most apical thread having a more aggressive cutting profile (see FIG. 13e). Conversely, allowing the minor diameter to migrate coronally will result in a most apical buttress thread. The deep conical connection 218 of this shorter implant 210 is shown in FIG. 13b-d. The combination multiple thread pattern of this design maintains the necessary wall thickness 220 between the deep conical connection 218 and the grooves of the thread patterns.

Alternatively, 60° 1X, 2X, 4X threads could be used with the coronal threads 212 being 0.22 mm apart and 0.12 mm deep and the middle threads 214 being 0.44 mm and 0.24 mm while the apical threads would be spaced 0.88 mm apart and be variable or of consistent depth.

The present disclosure addresses the issue of limited wall thickness associated with a deep conical connection. However, there are other advantages inherent in the design that could equally be applied to the implant with a different abutment connection Accordingly, while particular embodiments of the invention have been shown and described, it will be apparent to those skilled in the art that changes and modifications may be made therein without departing from the invention if its broader aspects, and, therefore, the aim in the appended claims is to cover all such changes and modifications as fall within the true spirit and scope of the present invention.

1. A dental implant for implanting within a human jawbone, the implant comprising:
an implant body having an outer surface, a longitudinal axis, a coronal end and an apical end; and
at least three externally threaded regions positioned on said outer surface, each of said regions including a pattern of a plurality of spaced apart threads, each of said regions exhibiting different thread timing, and each of said threads having an outside diameter, wherein the spacing between threads in said regions transitions from smaller spacing between the threads in a region to larger spacing between the threads in an adjacent region from the coronal end to the apical end along said longitudinal axis, and wherein the outside diameter of any thread in said regions is equal to or larger than the outside diameter of any thread apically disposed thereto.

2. The dental implant of claim 1 wherein said coronal end includes a deep female conical receptor creating a wall thickness between said outer surface and said conical receptor.

3. A dental implant for implanting within a human jawbone, the implant comprising:
a body having an outer surface, a longitudinal axis, a coronal end and an apical end;
said coronal end includes a deep female conical receptor creating a wall thickness between said outer surface and said receptor; and
at least three externally threaded regions positioned on said outer surface, each of said regions including a pattern of a plurality of spaced apart threads, each of said regions exhibiting different thread timing, and each of said threads having an outside diameter, wherein the spacing between threads in said regions transitions from smaller spacing between the threads in a region to larger spacing between the threads in an adjacent region from the coronal end to the apical end along said longitudinal axis, and wherein the outside diameter of any thread in said regions is equal to or larger than the outside diameter of any thread apically disposed thereto.

4. The dental implant of claim 1 or 3 wherein said body is tapered.

5. The dental implant of claim 4 wherein said taper is a step wise taper from the coronal end to the apical end.

6. The dental implant of claim 3 wherein said coronal end is a straight top end.

7. (canceled)

8. The dental implant of claim 3 further including a parallel threaded or grooved region on said outer surface, said parallel threaded or grooved region located coronally relative to said at least three externally threaded regions.

9. A dental implant for implanting within a human jawbone, the implant comprising: a longitudinal implant body having an outer surface, an apical end and a coronal end; wherein a series of three or more thread size patterns starting near the coronal end of said body are in series such that a space between threads in each of said thread size patterns become progressively larger, deeper and/or wider in size when moving from the coronal end to the apical end of said implant body, and wherein said at least three of said three or more thread size patterns exhibit different thread timing.

10. A dental implant for implanting within a human jawbone, the implant comprising: a longitudinal body having an outer surface, an apical end and a coronal end; wherein a first thread pattern comprising small circular grooves is positioned near the coronal end of said body and two or more additional thread patterns are apically disposed in series relative to said grooves, wherein the spacing between threads in said additional thread patterns transitions from smaller spacing between the threads in a pattern to larger spacing between the threads in an adjacent pattern from the coronal end to the apical end of said implant body, said thread patterns each exhibiting different thread timing, and wherein the outside diameter of any thread in said regions is equal to or larger than the outside diameter of any thread apically disposed thereto.

11. A dental implant for implanting within a human jawbone, the implant comprising: a longitudinal body having an outer surface, an apical end and a coronal end; wherein two thread patterns comprising circular grooves are positioned near the coronal end of said body and two or more additional thread patterns are apically disposed in series relative to said grooves such that a space between threads in each of said additional thread patterns become progressively wider in size when moving from the coronal end to in the apical end of said implant body, wherein each of said threads has an outside diameter and the outside diameter of any thread in said patterns is equal to or larger than the outside diameter of any thread apically disposed thereto, and wherein the two or more additional thread patterns exhibit different thread timing.

12. The dental implant of claims 1, 3, 9, 10 or 11 such that two or more of the thread patterns are multi-lead.

13. The dental implant of claim 12 such that one of the thread patterns is single lead.

14. The dental implant of claim 12 such that the thread patterns are all of the same thread pitch.

15. The dental implant of claim 12 such that only some of the thread patterns are of the same thread pitch.

16. The dental implant of claims 9, 10 or 11 such that the thread patterns are all single lead and not of the same thread pitch.

17. The dental implant of claims 1, 3, 9, 10 or 11 such that the minor diameter of the apical thread pattern moves progressively in an apical direction so that the thread flank angles vary continuously.

18. The dental implant of claims 1, 3, 9, 10 or 11 such that the minor diameter of the apical thread pattern moves progressively in a coronal direction so the thread flank angles vary continuously.

19. The dental implant of claim 12 such that the thread patterns are all of the same thread pitch.

20. The dental implant of claim 12 such that only some of the thread patterns are of the same pitch.

21. The dental implant of claim 1 or 3 wherein the threads have an internal thread angle and the internal thread angel in said at least three regions is equal to or greater than 60 degrees and less than or equal to 80 degrees.

22. The dental implant of claims 1 or 3 wherein the thread have an internal thread angle and the internal thread angle of at least two adjacent regions of said at least three regions is equal to each other.

23. The dental implant of claim 22 wherein said equal internal thread angle is 80°.

24. The dental implant of claim 22 wherein the internal thread angle of said at least three regions is 80°.

25. The dental implant of claim 10 wherein the threads have an internal thread angle and the internal thread angle of at least two of said two or more additional thread patterns is equal to each other.

26. The dental implant of claim 25 wherein said equal internal thread angle is 80°.
